(19) United States
(12) Patent Application Publication
(10) Pub. No.: US 2026/0010830 A1
(43) Pub. Date: Jan. 8, 2026

(54) SYSTEM AND METHOD FOR DYNAMIC REFINEMENT AND INFERENCE OF DATASETS USING MACHINE LEARNING MODELS

(71) Applicant: deadhead, LLC, Nashville, TN (US)

(72) Inventors: Daniel Carter Patten, Nashville, TN (US); Eric Angelo Scalzo, Nashville, TN (US)

(21) Appl. No.: 19/252,676

(22) Filed: Jun. 27, 2025

Related U.S. Application Data
(60) Provisional application No. 63/667,590, filed on Jul. 3, 2024.

(51) Int. Cl. G06N 20/00; G06Q 10/0637

(52) U.S. Cl. CPC G06N 20/00; G06Q 10/0637

(57) ABSTRACT

Computer-implemented systems and methods for dynamic refinement and inference of datasets are disclosed herein. The systems and methods may include a segmental feedback process to enhance the context, analysis, or reasoning of data in datasets used in machine learning models to provide refinement, enrichment, and inference by using the segmental feedback process to create a dynamic dataset (DD) to inform machine learning models, such as generative AI models or LLMs. The DD may be created based on a user, group of users, organization, or subject matter. A notification indicating when a user’s decision, action, or choice deviates from the machine learning model’s expected outcome provides an opportunity for the user to input feedback or the systems and methods to capture context to further refine, enrich, and enhance the DD. The systems and methods may apply the inferences to workstreams, analysis, or decisions for a user, group of users, or organization.

This application claims priority to and the benefit of U.S. Provisional Patent Application No. 63/667,590, filed July 3, 2024, which is incorporated by reference in its entirety.

### TECHNICAL FIELD

The present disclosure generally relates to machine learning model datasets, and more particularly to systems and methods for dynamic refinement and inference of datasets using machine learning models.

### RELATED APPLICATIONS

This application claims priority to and the benefit of U.S. Provisional Patent Application No. 63/667,590, filed July 3, 2024, which is incorporated by reference in its entirety.

### BACKGROUND

The present disclosure generally relates to machine learning model datasets. Current use of datasets in large language models (LLMs) focuses on an entire body of knowledge to train LLMs to generate outputs, which creates a static LLM that must be retrained with new data when advances in the body of knowledge are made or when there are changes to the underlying datasets (e.g., a new statute changes a particular law). Current knowledge management systems are siloed to specific users, groups of users or organizations. While necessary to protect proprietary or confidential information, the siloing of information in knowledge management systems leads to inefficiencies in cross-organizational workstreams. What is needed are systems and methods for dynamic refinement and inference of datasets for machine learning models and for safely sharing the information of knowledge management systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to machine learning model datasets, and more particularly to systems and methods for dynamic refinement and inference of datasets using machine learning models. In particular, the dynamic refinement and inference of datasets includes creating dynamic datasets and the storage, application, and sharing of the dynamic datasets by and amongst users, groups of users, and organizations. More specifically, the systems and methods of the present disclosure provide for the dynamic refinement, enrichment, and inference of datasets that can interact with machine learning models (e.g., LLMs, generative Al models) through a segmental feedback process.

Currently, datasets in LLMs focus on an entire body of knowledge to train the LLMs to generate outputs, which creates a static LLM that must be retrained with new data when advances in the body of knowledge are made or when there are changes to the underlying datasets (e.g., a new statute changes a particular law). The systems and methods of the present disclosure relate to a user or a group of users' analysis, reasoning, and decision making with respect to the user's or group's workstreams. In particular, the systems and methods may create objective (e.g., industry specific) or subjective (e.g., user-specific, group-specific, or organization-specific) dynamic datasets. A dynamic dataset can sit on top of and interact with a machine learning model (e.g., an LLM), thereby providing additional input, context, and reasoning to allow the model output to be more precise, up-to-date, and better reasoned, as well as to be tailored to the user, group, or organization. As a result, the dynamic datasets can be specific for industries, users, groups, or organizations, and provide for dynamic machine learning models that can respond to changes in the dynamic datasets, instead of static models that must be retrained with new data when advances in the body of knowledge are made or when there are changes to the underlying datasets.

Similarly, current knowledge management systems are siloed to specific users, groups of users, or organizations which, while necessary to protect proprietary or confidential information, leads to inefficiencies in cross-organizational workstreams. The systems and methods of the present disclosure can provide for cross-organizational sharing of the dynamic datasets, thereby maintaining the security, privacy, and confidentiality of the underlying information, while permitting multiple organizations to access and benefit from a dynamic dataset of the users, groups of users, or organizations with whom they are interacting. Such cross-organizational sharing of the dynamic datasets may be subject to appropriate permissions and securities to ensure the protection of sensitive, confidential, and proprietary information, allowing for the safe sharing of the information of knowledge management systems.

One aspect of the disclosure is a method. The method may include a method for creating dynamic datasets for machine learning models. The method may include accessing, by a computing device, a dataset for a machine learning model associated with a user, group of users, organization, or subject matter. The method may include generating, by the computing device, at least one feedback field configured for an input to provide additional context, analysis, or reasoning for the user, group of users, organization, or subject matter. The method may include receiving, by the computing device, additional context, analysis, or reasoning from the at least one feedback field. The method may include applying, by the computing device, the additional context, analysis, or reasoning to the dataset to create a dynamic dataset for the machine learning model. The method may include applying, by the computing device, the machine learning model informed by the dynamic dataset to workstreams, analysis, or decisions for the user, group of users, organization, or subject matter based on permissions and securities of the user, group of users, organization, or subject matter. The method may include receiving, by the computing device, an output generated by the machine learning model, the output comprising a response tailored to the user, group of users, organization, or subject matter.

Another aspect of the disclosure is another method. The method may include a method for refinement and inference of datasets for machine learning models. The method may include generating, by a computing device, a prompt for user input. The method may include receiving, by the computing device, a response to the prompt from a user. The method may include routing, by the computing device, the response to the prompt to a machine learning model through a dynamic dataset comprising a rule library and a project context. The method may include receiving, by the computing device, a proposed response to the prompt from the machine learning model. The method may include performing, by the computing device, a comparison of the response to the prompt to the proposed response to the prompt. The method may include generating, by the computing device, feedback based on the comparison, wherein the comparison indicates whether the proposed response to the prompt is consistent or inconsistent with the response to the prompt. The method may include updating, by the computing device, one or more of the rule library or the project context based on the feedback.

Another aspect of the disclosure is a system. The system may include a system for refinement and inference of datasets for machine learning models. The system may include at least one machine learning model comprising a generative AI model or a large language model (LLM), at least one memory storing the at least one machine learning model and non-transitory computer-executable instructions, and at least one processor. The non-transitory computer-executable instructions, when executed by the at least one processor, may cause the at least one processor to perform operations. The operations may include accessing a dataset for the at least one machine learning model associated with a user. The operations may include receiving additional context, analysis, or reasoning from the user. The operations may include applying the additional context, analysis, or reasoning to the dataset to create a dynamic dataset for the at least one machine learning model. The operations may include generating a prompt for user input. The operations may include receiving a response to the prompt from the user. The operations may include routing the response to the prompt to the at least one machine learning model through the dynamic dataset. The operations may include receiving a proposed response to the prompt from the at least one machine learning model. The operations may include performing a comparison of the response to the prompt to the proposed response to the prompt. The operations may include generating feedback based on the comparison, wherein the comparison indicates whether the proposed response to the prompt is consistent or inconsistent with the response to the prompt. The operations may include updating the dynamic dataset based on the feedback.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1 is a block diagram illustrating an example embodiment of a system of the present disclosure.

FIG. 2 is sequence flow diagram illustrating an example embodiment of a system of the present disclosure.

FIGS. 3A-3E are sequence flow diagrams illustrating an example embodiment of a system of the present disclosure.

FIG. 4 is a flowchart diagram illustrating an example embodiment of a method of the present disclosure.

FIG. 5 is a flowchart diagram illustrating an example embodiment of a method of the present disclosure.

### DETAILED DESCRIPTION

Reference will now be made in detail to exemplary embodiments of the disclosure, some aspects of which are illustrated in the accompanying drawings.

Reference throughout this specification to "one embodiment," "an embodiment," "another embodiment," or similar language means that a particular feature, structure, or characteristic described in connection with the embodiment is included in at least one embodiment. Thus, appearances of the phrases "in one embodiment," "in an embodiment," "in some embodiments," and similar language throughout this specification may, but do not necessarily, all refer to the same embodiment and should be understood to mean "one or more but not necessarily all embodiments" unless expressly specified otherwise.

The terms "including," "comprising," "having," and variations thereof mean "including but not limited to" unless expressly specified otherwise. An enumerated listing of items does not imply that any or all of the items are mutually exclusive and/or mutually inclusive, unless expressly specified otherwise. As used herein, the term "a," "an," or "the" means "one or more" unless otherwise specified. The term "or" means "and/or" unless otherwise specified.

Multiple elements of the same or a similar type may be referred to as "Elements 102(1)- (n)" where n may include a number. Referring to one of the elements as "Element 102" refers to any single element of the Elements 102(1)-(n). Additionally, referring to different elements "First Elements 102(1)-(n)" and "Second Elements 104(1)-(n)" does not necessarily mean that there must be the same number of First Elements as Second Elements and is equivalent to "First Elements 102(1)-(n)" and "Second Elements (1)-(m)" where m is a number that may be the same or may be a different number than n.

The present disclosure is directed to systems and methods for dynamic refinement and inference of datasets using machine learning models. Dynamic refinement and inference of datasets may be used to create dynamic datasets, which may be stored, applied, and shared amongst users, groups of users and organizations, including multiple organizations. The computer- implemented systems and methods of the present disclosure may include a segmental feedback process to enhance the context, analysis, or reasoning of data contained in datasets used in artificial intelligence (AI) models to provide refinement, enrichment, and inference of the data. The systems and methods may employ the segmental feedback process to create a dynamic dataset to inform machine learning models, such as LLMs and generative Al models. The dynamic datasets can also interact with other machine learning models through the segmental feedback process.

A dynamic dataset may also be created based on a particular user, group of users, organization, or subject matter. Automatically or manually initiated feedback fields or captured data may allow users to provide, or the system to capture, additional context, analysis, or reasoning to specific and segmented decisions or actions taken. The systems and methods may further indicate when a user's decision, action, or choice deviates from the expected outcome of the machine learning model informed by the dynamic dataset, providing an opportunity for the user to input feedback, or the system to capture, context to further refine, enrich, and enhance the dynamic dataset. This enhanced inference capability may be applied to future workstreams, analysis, or decisions for that particular user, a group of users, that user or group of users' organization, or other organizations based on permissions and securities.

The systems and methods may further allow multiple organizations to share dynamic datasets with other organizations or users. Users, groups of users, and organizations may have the ability to provide additional feedback through the above referenced segmental feedback process or through other methods to further enhance the dynamic datasets, subject to applicable permissions and securities. The systems and methods may further allow for extraction and transfer of a particular user's, group of users', or organization's dynamic datasets, or a portion thereof, to another user or organization, such as by cloning the applicable dynamic dataset or transferring the complete dynamic dataset, subject to applicable permissions and securities.

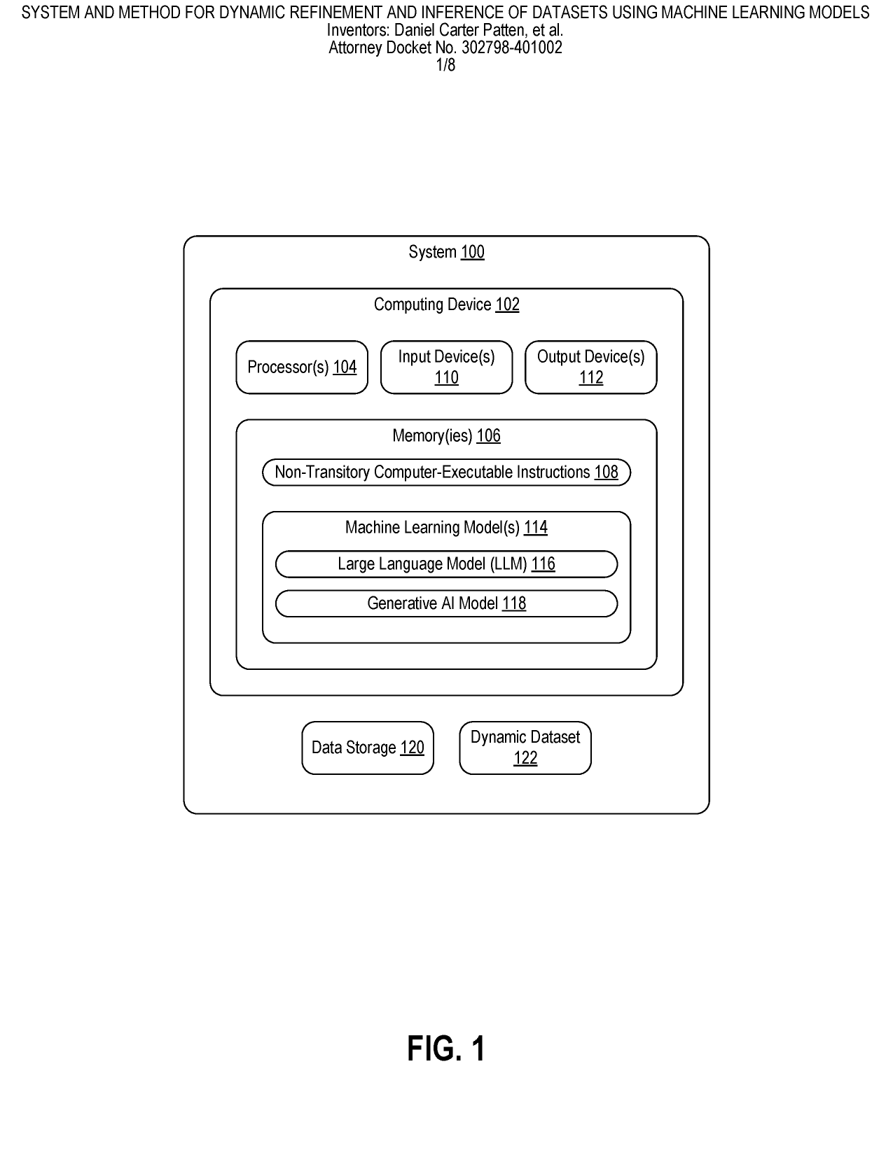

FIG. 1 is a block diagram illustrating an example embodiment of a system 100 of the present disclosure. The system 100 may include a computing device 102 with at least one processor 104 and at least one memory 106. The at least one memory 106 can store non-transitory computer- executable instructions 108. The computing device 102 may also comprise one or more input devices 110 and one or more output devices 112. In some embodiments, the at least one memory 106 may include one or more machine learning models 114. The machine learning models 114 may include at least one large language model (LLM) 116 and/or at least one generative Al model 118. In some embodiments, data storage 120 may be provided in the system 100, such as a database. The non-transitory computer-executable instructions 108, upon execution by the at least one processor 104, can cause the computing device 102 to perform operations for dynamic refinement and inference of datasets using machine learning models, including creating dynamic datasets 122 for the machine learning models 114.

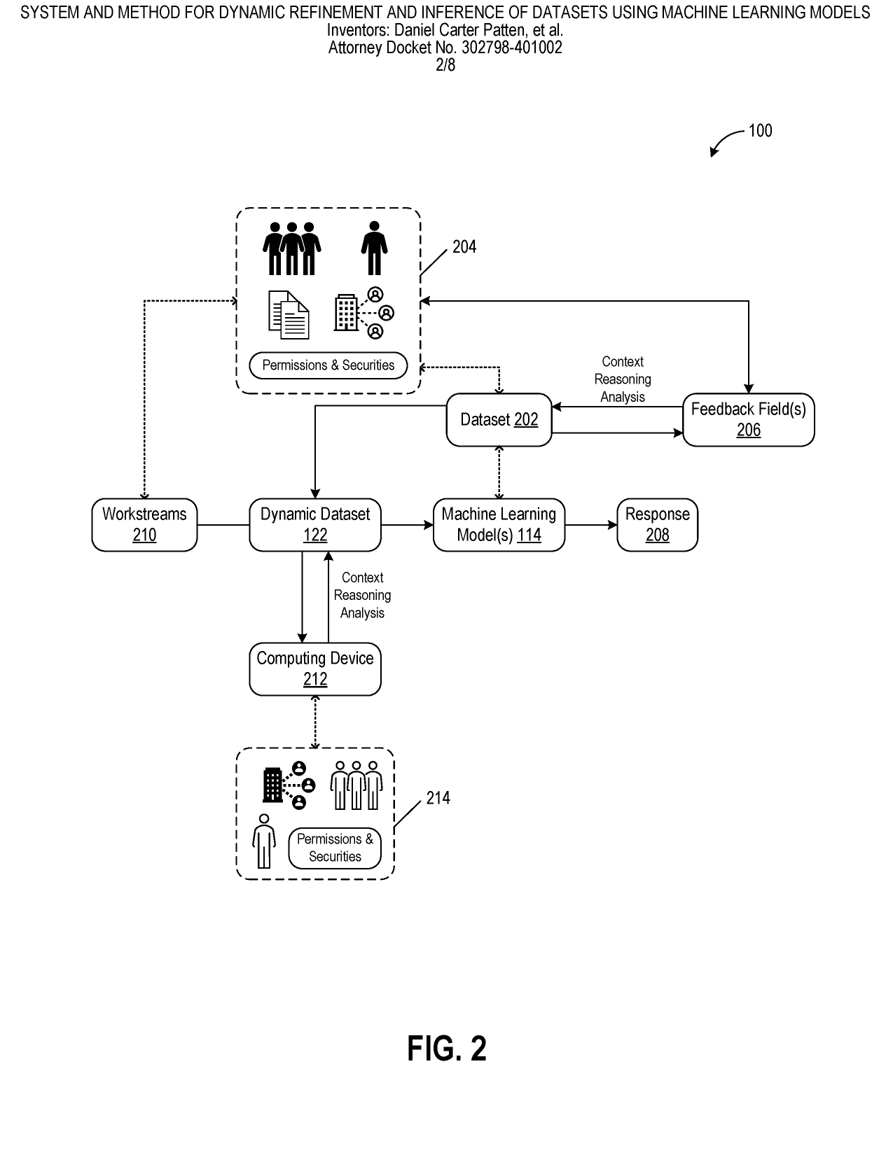

FIG. 2 is a sequence flow diagram illustrating an example embodiment of the system 100 of the present disclosure. In the example of FIG. 2, a computer-implemented system and method for dynamic refinement and inference of datasets using machine learning models is provided, including creating dynamic datasets for machine learning models, such as generative Al models. The system 100 includes a segmental feedback process to enhance the context, analysis, or reasoning of data contained in datasets 202 used in the machine learning models 114 to provide refinement, enrichment, and inference of the data provided in the datasets 202. The segmental feedback process may be used to create a dynamic dataset 122 to inform language in inference models (e.g., LLMs 116). The dynamic dataset 122 may also inform a generative Al model 118. A dynamic dataset 122 may be created based on a particular user, group of users, organization, or subject matter 204. For instance, a dataset 202 associated with a user, group of users, organization, or subject matter 204 and a machine learning model 114 (e.g., LLM 116, generative Al model 118) associated with the user, group of users, organization, or subject matter 204 can be used as a basis for creating a dynamic dataset 122 for the refinement, enrichment, and inference of the dataset 202 to inform the machine learning model 114.

Feedback fields 206 may be automatically or manually initiated to allow users or the system 100, to provide additional context, analysis, or reasoning, such as to specific and segmented decisions or actions taken by the users or the system 100. For instance, users 204 or the system 100 may provide additional context, reasoning, or analysis to further refine the dynamic dataset 122 associated with the machine learning model 114. Users may provide such context, reasoning, or analysis in real-time as part of the user's workflow, delay providing such context, reasoning, or analysis until a later time, or decline to provide such context, reasoning, or analysis at any time. The resulting dynamic dataset 122 allows the machine learning model 114 output response 208 to be more precise, up-to-date, and better reasoned, as well as to be tailored to the user, group of users, organization, or subject matter 204. The system 100 may also include the ability to apply the dynamic dataset 122 to future workstreams, analysis, or decisions 210 for a particular user, group of users, the user's or group of users' organization 204, or other organizations based on permissions and securities of the users or organization.

Multiple organizations may share the dynamic dataset 122 with other organizations or users. The users, groups of users, organization, or multiple other organizations, may provide additional feedback through the segmental feedback process described herein to further enhance the dynamic dataset 122, subject to applicable permissions and securities. For example, the dynamic dataset 122 may be transmitted to a computing device 212 associated with another user, group of users, or organization 214 based on its permissions and securities and the permissions and securities of the user, group of users, organization, or subject matter 204 to provide additional context, reasoning, or analysis for the dynamic dataset 122. Such sharing of the dynamic dataset 122 may be on a temporary basis for a specific period of time (e.g., for the length of a given project) or may be indefinite based on organizational needs. In another embodiment, a particular user's, group of users', or organization's 204 dynamic dataset 122 may be extracted and transferred to another user, group of users, or organization 214, such as by cloning the applicable dynamic dataset 122 or transferring it completely (e.g., to the computing device 212 associated with the other user, group of users, or organization 214), subject to applicable permissions and securities.

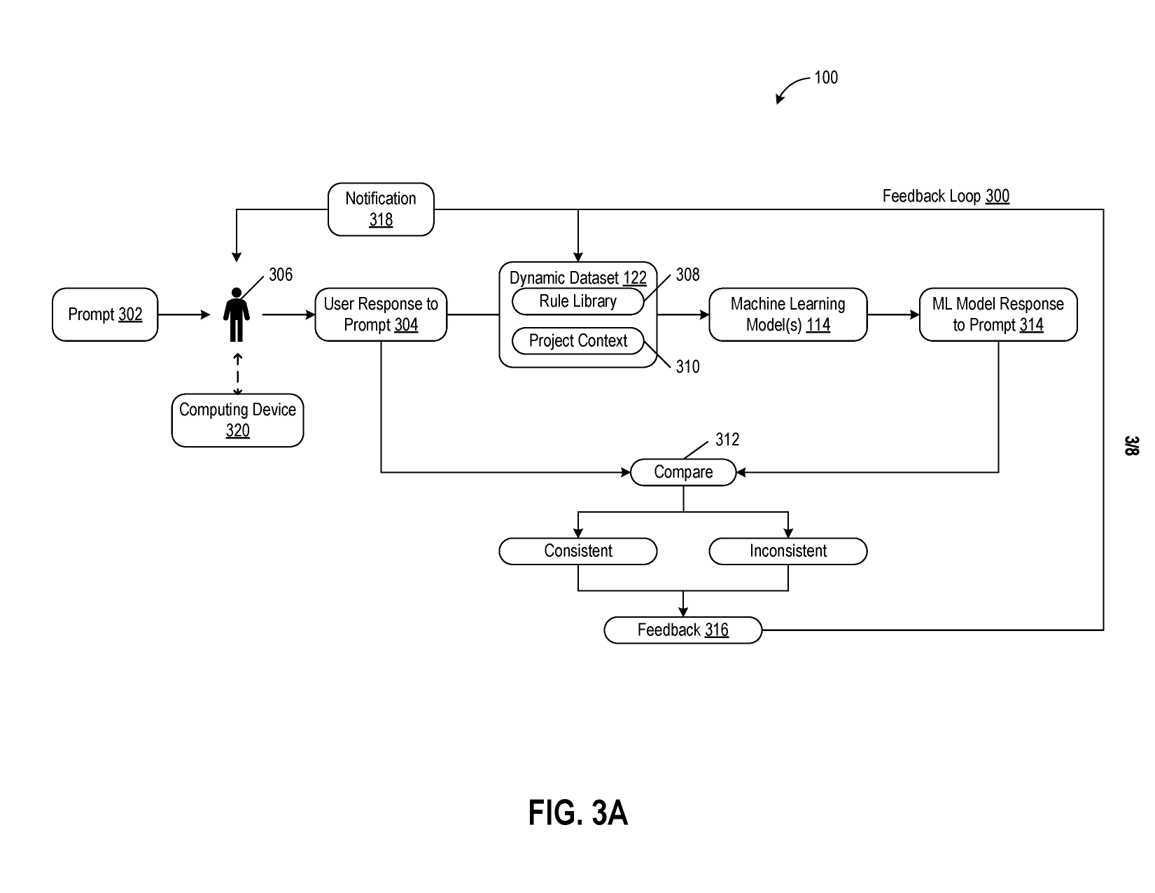

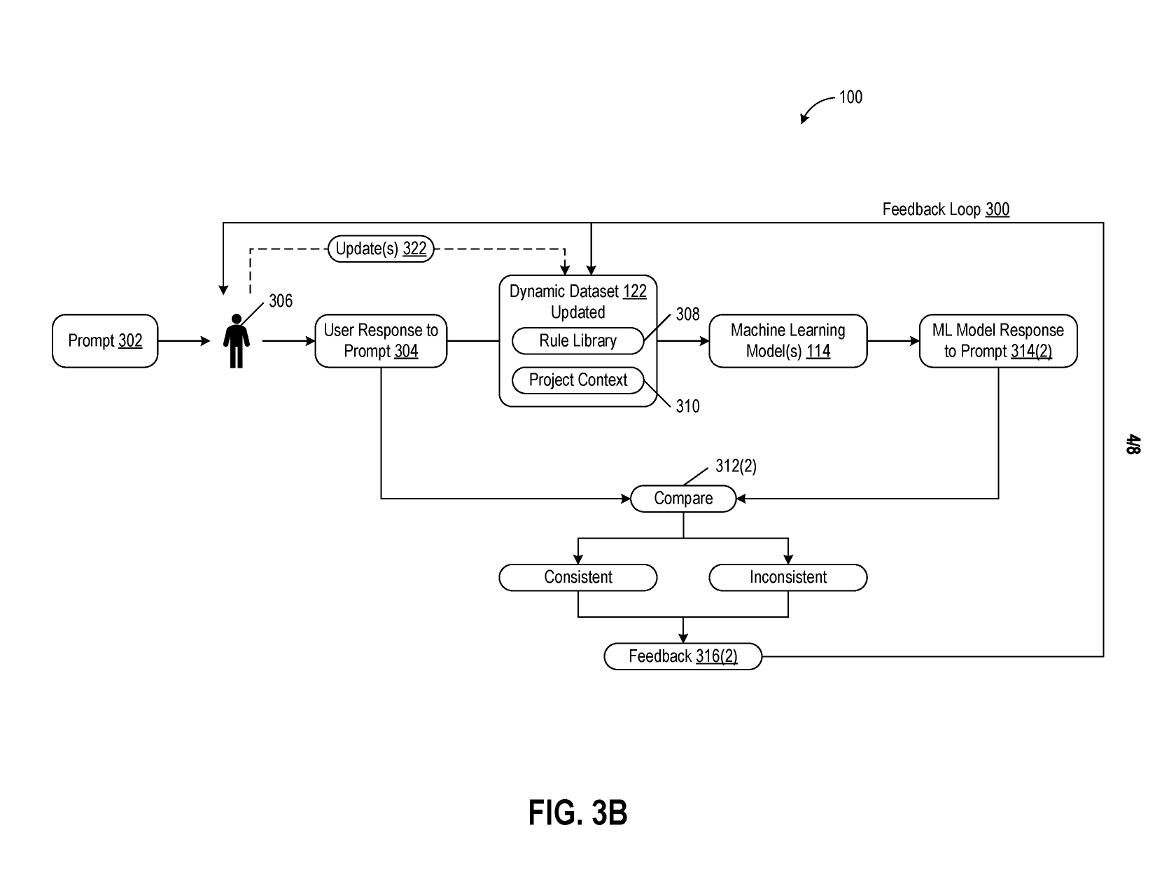

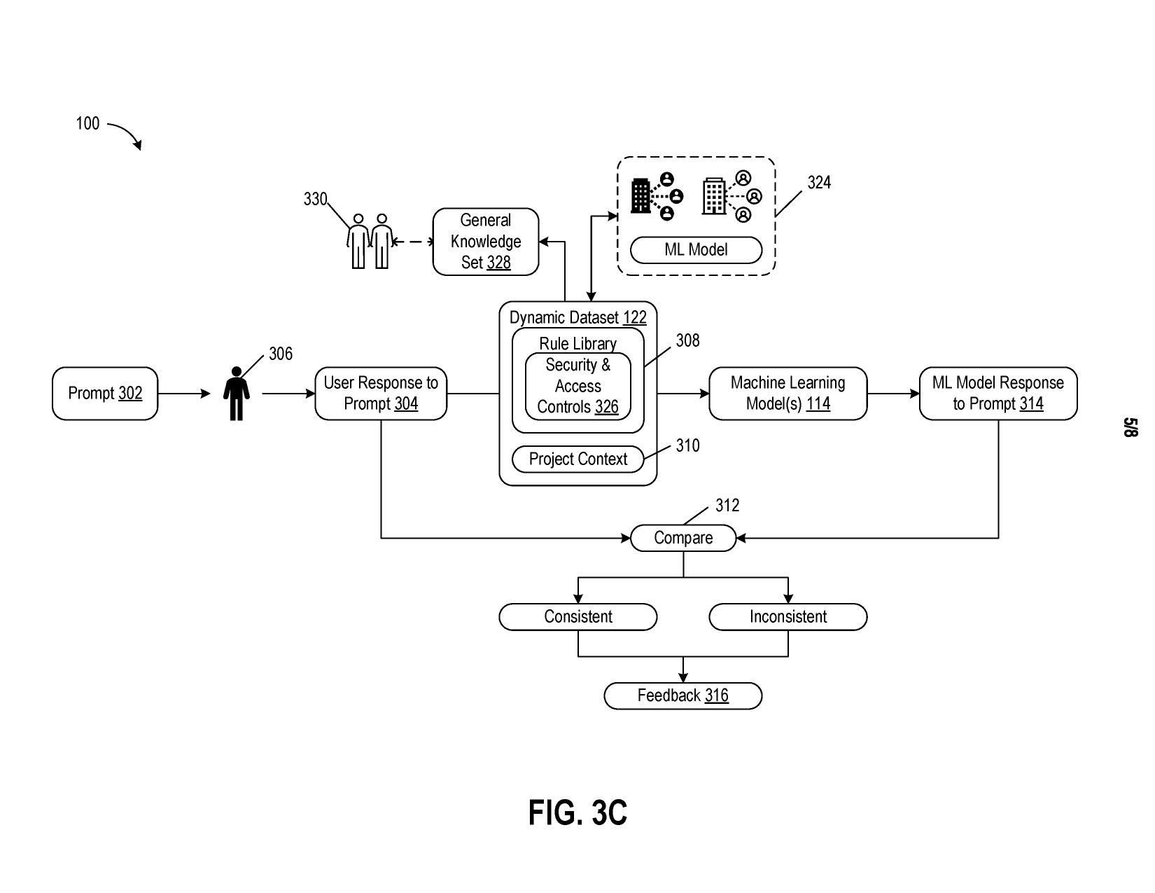

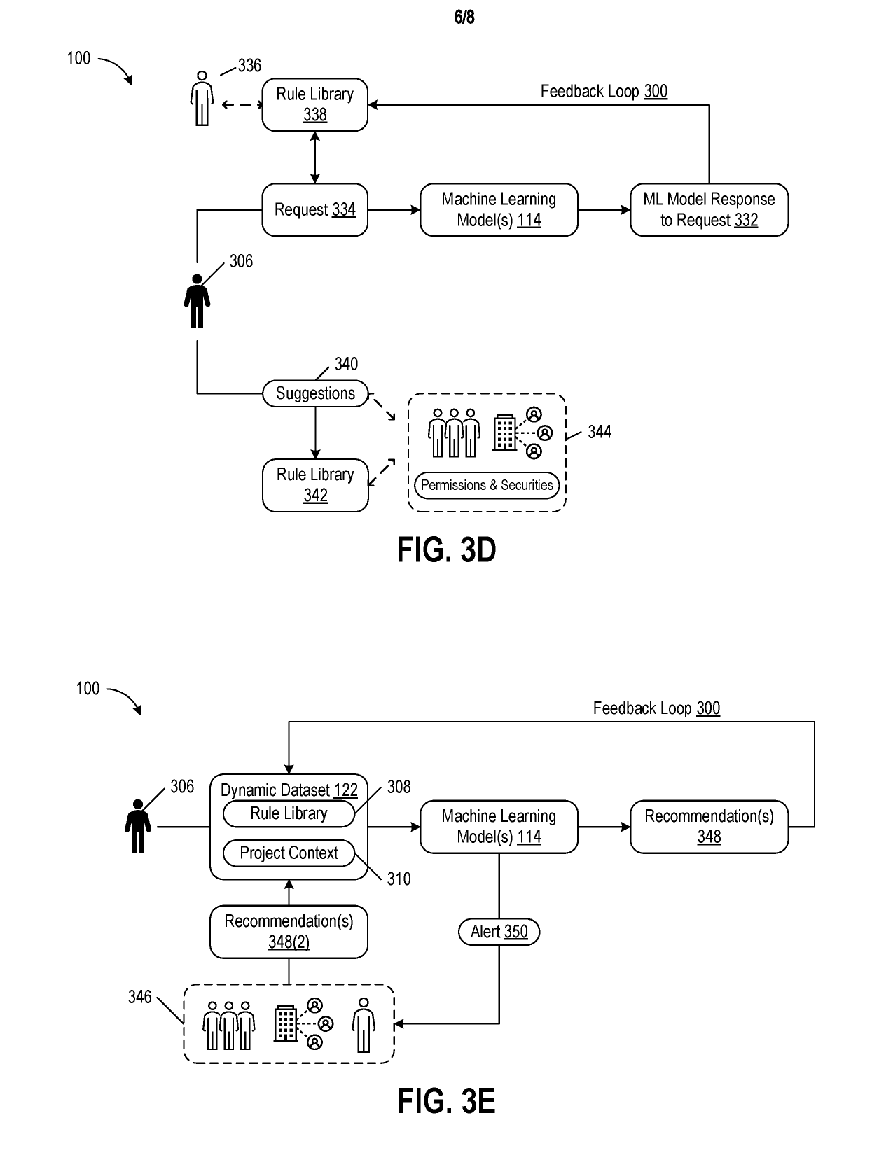

FIGS. 3A-3E are sequence flow diagrams illustrating an example embodiment of the system 100 of the present disclosure. In the examples of FIGS. 3A-3E, a computer-implemented system and method for dynamic refinement and inference of datasets using machine learning models, such as generative Al models, is provided. The system 100 may include the segmental feedback process described herein to enhance the context, analysis, or reasoning of data contained in datasets used in the machine learning models 114 to provide refinement, enrichment, and inference of the data provided in the datasets. The segmental feedback process may include generating a prompt 302 for user input, and a user 306 may then input a response 304 to the prompt 302. The segmental feedback process may include routing the response 304 to the prompt 302 received from the user 306 to the user's machine learning model 114 (e.g., LLM 116 or generative Al model 118) through a dynamic dataset 122 composed of a user-controlled rule set, such as a rule library 308, and specific context, such as a project context 310, surrounding the prompt 302. In some implementations, the rule library 308 may be a table of authorities regarding rules or understandings. For instance, the rule library 308 may contain specific preferences for the user 306, a group of users, or an organization, which may be in the form of rules. The rule library 308 may be more accurate than the machine learning models 114 in some examples.

The response 304 to the prompt 302 may be compared 312 in real-time to a proposed response 314 generated by the machine learning model 114 in response to routing the response 304 to the prompt 302 to the machine learning model 114 through the dynamic dataset 122. The user 306 may be provided real-time feedback 316 including whether the proposed response 314 from the machine learning model 114 is consistent or inconsistent with the user's response 304 to the prompt 302. Alerts, notifications 318, or prompts may be generated with the feedback 316 and displayed (e.g., on a user computing device 320 associated with the user 306) to indicate when a user's decision or input is consistent or inconsistent with an expected decision, action, output, or outcome of the machine learning model 114 informed by the dynamic dataset 122. The system 100 may continue such a feedback loop 300 to provide notifications and/or prompts for additional context, analysis, or reasoning until (1) the machine learning model 114 informed by the dynamic dataset 122 provides a decision or action (i.e., machine learning model's 114 proposed response 314) to the user's 306 expected output or outcome (i.e., user response 304), or (2) the user 306 decides to cease providing additional context, reasoning, or analysis. The user 306 may generate the proposed response 314 via the machine learning model 114 to understand how the machine learning model 114 responds to prompts 302, and the user 306 or the system 100 may interact with the machine learning model 114 to understand why the generated response 314 may be correct or incorrect.

FIG. 3B illustrates that in the feedback loop 300, the user or the system 100 may update 322 the rule library 308 with specific information, preferences, reasonings, or understandings (e.g., additional or changes in information, preferences, reasonings, or understandings of the user 306, a group of users, or an organization, which may be in the form of rules) or update 322 the project context 310 to better refine and prompt the machine learning model 114, which can better inform the machine learning model 114 and produce a response 314(2) from the machine learning model 114 that is consistent with the user's 306 needs or expectations. In some examples, the update(s) 322 to the rule library 308 and/or the project context 310 may be based on the feedback 316. The user 306 or the system 100 can then re-execute the comparison 312(2) and receive feedback 316(2) that may be generated if the changes to the rule library 308 or the project context 310 result in a consistent response 314(2). The user 306 or the system 100 may continue to send update(s) 322 to the rule library 308 and/or project context 310 if an inconsistent response 314(2) is indicated by the feedback 316(2). In some embodiments, the rule library 308 can be updated outside the feedback loop 300 to allow users to fine tune, change security or access controls, or otherwise manage the system 100. In some implementations, the rule library 308 can be integrated in external (e.g., third-party) systems and be interoperable with those systems.

In some embodiments, actions, decisions, or outcomes may be recommended by the system 100 based on a context of user, group, or organizational work processes (e.g., the project context 310). The user 306 or the system 100 can then evaluate, refine, or adopt such actions, decisions, or outcomes. The user 306 or the system 100 can then update 322 the rule library 308 and/or the project context 310 with specific information, preferences, reasoning, or understanding based on the actions, decisions, or outcomes to improve future recommendations.

In some examples, the rule library 308 can be used by multiple organizations 324, whether or not the organizations use the same machine learning models, as illustrated in . In examples where the rule library 308 includes rules, the rules in the rule library 308 may have security and/or access controls 326 to allow portability and sharing of knowledge across users, organizations, and systems. In some implementations, the rule library 308 may be de-identified to allow non-user-specific preferences to form a general knowledge set 328 for use by other users 330.

In some embodiments, the user 306 or the system 100 may generate a response 332 from the machine learning model 114 by executing a request 334 that utilizes another user's 336 rule library 338, subject to applicable permissions and securities, as illustrated in FIG. 3D. In some embodiments, the user 306 can provide a suggestion 340 of context, analysis, and/or decisions to be included in a rule library 342 for an organization or group of users 344, either generally or on a project-specific basis (e.g., based on a project context). Other users or groups of users can review, modify, and/or accept or reject such inclusions, subject to applicable permissions and securities.

As illustrated in FIG. 3E, in some embodiments, an organization or group of users 346 or the system 100 can generate recommended actions, decisions, and/or outcomes 348 based on a context of user, group, or organizational work process (e.g., the project context). For example, the system 100 may receive recommended actions, decisions, and/or outcomes 348(2) from the organization or group of users 346. The machine learning model 114 can alert 350 the organization or group of users 346 in response when a user deviates from such recommended action, decision, or outcome 348(2), subject to applicable permissions and securities. The user 306 or the system 100 may then update the rule library 308 and/or the project context 310 with specific information, preferences, reasoning, or understanding based on the recommended actions, decisions, or outcomes to better refine future recommendations generated by the machine learning model 114.

It should be understood that actions performed by a user, organization, or group of users may be performed by the computing device 102 of the system 100 of the present disclosure in some examples.

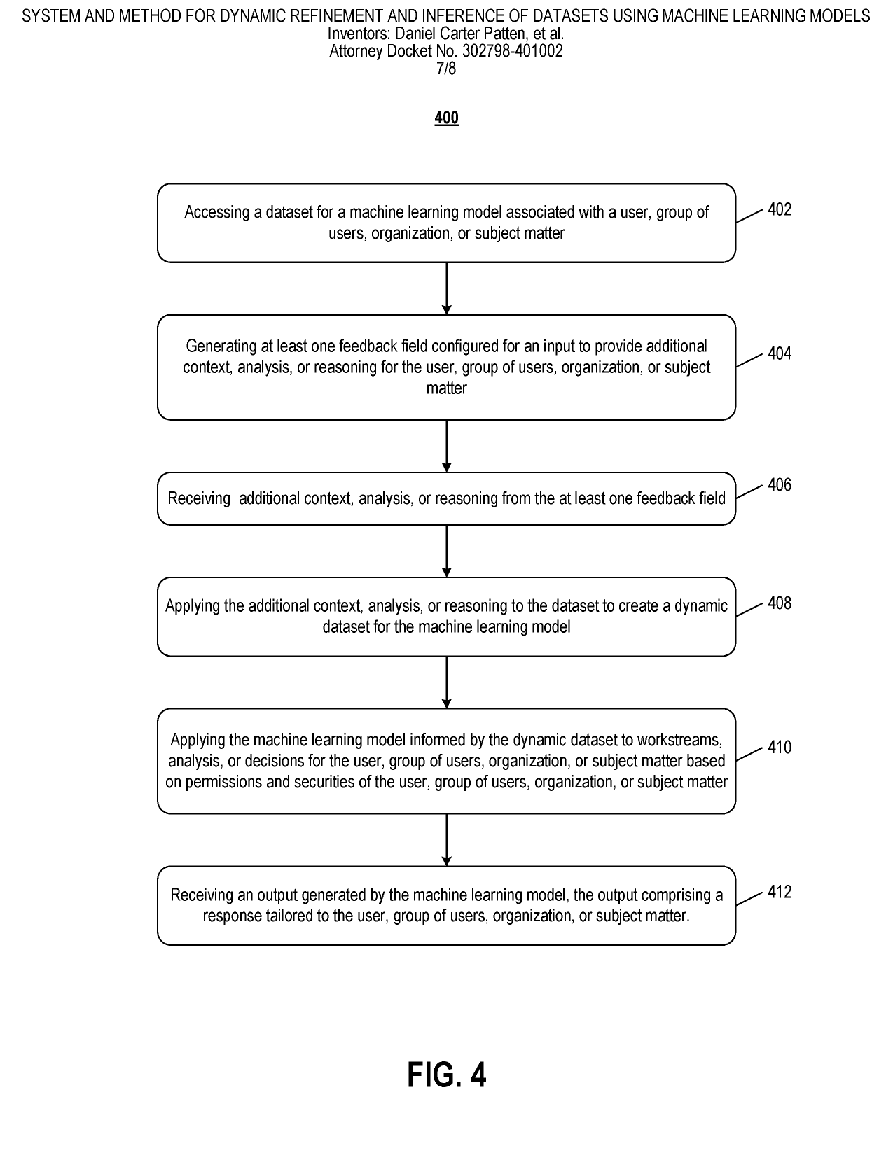

FIG. 4 is a flowchart diagram illustrating an example embodiment of a method 400 of the present disclosure. In certain embodiments, the method 400 for dynamic refinement and inference of datasets using machine learning models may include the step of providing at least one memory 106. In some embodiments, the at least one memory 106 may include the one or more machine learning models 114. The machine learning models 114 may include at least one large language model (LLM) 116 and/or at least one generative AI model 118. The at least one memory 106 may store non-transitory computer-executable instructions 108 for creating dynamic datasets for machine learning models. When executed by the computing device 102 with the at least one processor 104, the non-transitory computer-executable instructions 108 cause the at least one processor 104 to perform operations 402-412.

The method 400 may include operation 402 of accessing a dataset for a machine learning model associated with a user, group of users, organization, or subject matter. The method 400 may include operation 404 of generating at least one feedback field configured for an input to provide additional context, analysis, or reasoning for the user, group of users, organization, or subject matter. The method 400 may include operation 406 of receiving additional context, analysis, or reasoning from the at least one feedback field. The method 400 may include operation 408 of applying the additional context, analysis, or reasoning to the dataset to create a dynamic dataset for the machine learning model. The method 400 may include operation 410 of applying the machine learning model informed by the dynamic dataset to workstreams, analysis, or decisions for the user, group of users, organization, or subject matter based on permissions and securities of the user, group of users, organization, or subject matter. The method 400 may include operation 412 of receiving an output generated by the machine learning model, the output comprising a response tailored to the user, group of users, organization, or subject matter. In some embodiments, the method 400 may further include an operation of transmitting the dynamic dataset to a computing device associated with another user, group of users, or organization based on the permissions and securities of the user, group of users, organization, or subject matter and permissions and securities of the other user or organization; receiving additional context, analysis, or reasoning from the other user or organization; and applying the additional context, analysis, or reasoning from the other user or organization to the dynamic dataset.

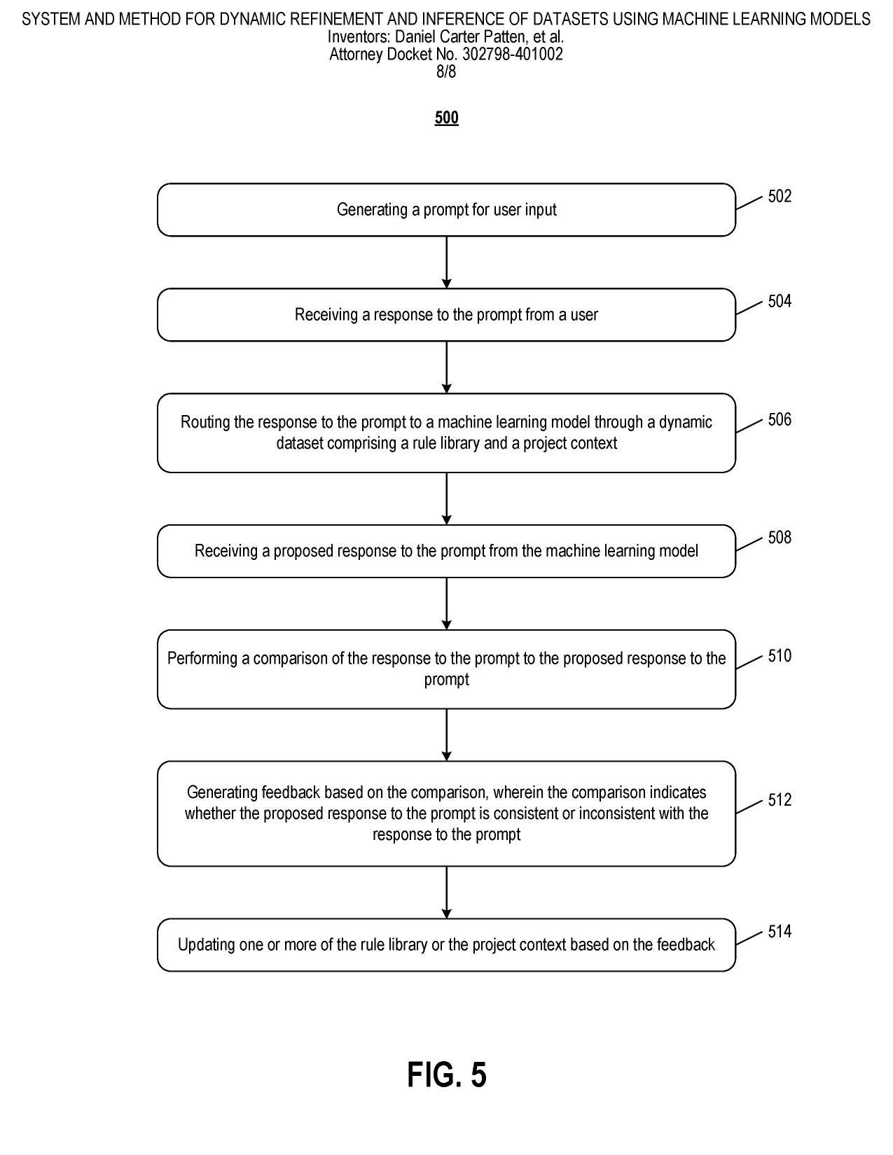

FIG. 5 is a flowchart diagram illustrating an example embodiment of a method 500 of the present disclosure. In certain embodiments, the method 500 for dynamic refinement and inference of datasets using machine learning models may include the step of providing at least one memory 106. In some embodiments, the at least one memory 106 may include the one or more machine learning models 114. The machine learning models 114 may include at least one large language model (LLM) 116 and/or at least one generative AI model 118. The at least one memory 106 may store non-transitory computer-executable instructions 108 for refinement and inference of datasets for machine learning models. When executed by the computing device 102 with the at least one processor 104, the non-transitory computer-executable instructions 108 cause the at least one processor 104 to perform operations 502-514.

The method 500 may include operation 502 of generating a prompt for user input. The method 500 may include operation 504 of receiving a response to the prompt from a user.

The method 500 may include operation 506 of routing the response to the prompt to a machine learning model through a dynamic dataset comprising a rule library and a project context. In some embodiments, the rule library may include a user-controlled rule set comprising at least one rule and a table of authorities regarding rules or understandings, and in some embodiments the table of authorities includes one or more of user preferences or organizational preferences. In some embodiments, the rule library is configured to be used by a plurality of organizations, wherein at least one organization from among the plurality of organizations uses a different machine learning model from other organizations in the plurality of organizations. In some embodiments, the rule library comprises security and access controls configured to allow sharing of knowledge across one or more of users, organizations, or systems. In some embodiments, the rule library is de- identified and includes non-user-specific preferences form a general knowledge set for use by other users. In some embodiments, the rule library is integrated in an external system and accessible from the external system.

The method 500 may include operation 508 of receiving a proposed response to the prompt from the machine learning model. The method 500 may include operation 510 of performing a comparison of the response to the prompt to the proposed response to the prompt. In some embodiments, performing the comparison of the response to the prompt to the proposed response to the prompt occurs in real-time; and generating the feedback based on the comparison occurs in real-time. The method 500 may include operation 512 of generating feedback based on the comparison, wherein the comparison indicates whether the proposed response to the prompt is consistent or inconsistent with the response to the prompt. The method 500 may include operation 514 of updating one or more of the rule library or the project context based on the feedback.

The method 500 may further include an operation of subsequent to updating the one or more of the project context or the rule library based on the feedback, routing the response to the prompt to the machine learning model through the dynamic dataset; receiving a second proposed response to the prompt from the machine learning model; performing a second comparison of the response to the prompt to the second proposed response to the prompt; generating additional feedback based on the second comparison, wherein the second comparison indicates whether the second proposed response to the prompt is consistent or inconsistent with the response to the prompt; and receiving one or more updates to one or more of the rule library or the project context when the additional feedback indicates inconsistent responses.

In some embodiments, the method 500 may further include an operation of generating a notification comprising the feedback, wherein the feedback indicates whether the proposed response to the prompt is consistent or inconsistent with the response to the prompt; and transmitting the notification to a computing device associated with the user and configured to display the notification. In some embodiments, the method 500 may further include an operation of receiving one or more of information, preferences, reasoning, or understanding from the user; and updating the rule library based on the one or more of information, preferences, reasoning, or understanding. In some embodiments, the method 500 may further include an operation of executing a request using a rule library from another user; and generating a response from the machine learning model based on the request. In some embodiments, the method 500 may further include an operation of receiving one or more suggestions for one or more of context, analysis, or decisions, wherein the one or more suggestions correspond to an organization; and including the one or more suggestions in the rule library, wherein the rule library corresponds to the organization.In some embodiments, the method 500 may further include an operation of receiving one or more of information, preferences, reasoning, or understanding; and updating the project context based on the one or more of information, preferences, reasoning, or understanding. In some embodiments, the method 500 may further include an operation of generating one or more recommendations comprising one or more of actions, decisions, or outcomes based on a context of user, group, or organizational work process. In some embodiments, the method 500 may further include an operation of receiving, from an organization or group of users, one or more of a recommended action, decision, or outcome for users of the organization or group of users; generating, based on the one or more of a recommended action, decision, or outcome for users of the organization or group of users, an alert when a user from the organization or group of users deviates from the one or more of a recommended action, decision, or outcome; and sending the alert to the organization or group of users.

The presently disclosed systems and methods have a wide application anywhere in machine learning where dynamic refinement and inference of datasets is needed. One particularly important application for the systems and methods described herein relates to generative AI models and creating dynamic datasets for the generative AI models. Additional systems and methods include allowing for cross-organizational sharing of datasets, even when different machine learning models are used, for knowledge management applications. However, the systems and methods described above could be utilized in other contexts.

As used herein, the term "computing device" may include a processor-controlled device, such as, by way of example, a personal computer, workstation, server, client, mini-computer, mainframe computer, desktop computer, laptop computer, smartphone, tablet, network of one or more individual computers, mobile computer, portable computer, handheld computer, or any combination thereof. The described systems and techniques may be performed by a system that includes a single computing device or more than one computing device.

A computing device may include an integrated circuit (IC) and may include an application- specific integrated circuit (ASIC) or some other type of IC. A computing device may be a uniprocessor or multiprocessor machine. Accordingly, a computing device may include one or more processors and, thus, the system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), programmable logic controllers (PLCs), gated logic, and other suitable hardware configured to perform the various functionality described throughout this disclosure. In some embodiments, features of the system can be implemented primarily in hardware using, for example, hardware components such as application-specific integrated circuits (ASICs) or field- programmable gated arrays (FPGAs). Implementation of the hardware circuitry will be apparent to persons skilled in the relevant art(s). In yet another embodiment, features of the system can be implemented using a combination of both general-purpose hardware and software.

The computing device may include at least one memory. Accordingly, the system may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, videotapes, audio tapes, magnetic recording tracks, magnetic tunnel junction (MTJ) memory, optical memory storage, quantum mechanical storage, electronic networks, and/or other devices or technologies used to store electronic content such as programs and data. A basic input/output system (BIOS) can include basic routines that help to transfer information between elements within the system, such as during start-up, can be stored in the one or more memories.

The system can also include one or more storage devices. Examples of a storage device include, but are not limited to, a hard disk drive, a magnetic disk drive, an optical disc drive in combination with an optical medium, a solid-state memory device, or any combination thereof. A storage device can be connected to a bus by an appropriate interface, such as an SCSI, advanced technology attachment (ATA), serial ATA, universal serial bus (USB), IEEE 1394 (FIREWIRE), or any combination thereof. A storage device (or one or more components thereof) can be removably interfaced with the system (e.g., via an external port connector). The storage device and an associated computer-readable medium can provide nonvolatile and/or volatile storage of computer-executable instructions, data structures, program modules, and/or other data for the system.

In particular, the one or more memories may store computer-executable instructions that, when executed by the one or more processors, cause the one or more processors to implement the procedures and techniques described herein. The one or more processors may be operably associated with the one or more memories so that the computer-executable instructions can be provided to the one or more processors for execution. For example, the one or more processors may be operably associated to the one or more memories through one or more buses. Furthermore, the computing device may possess or may be operably associated with input devices (e.g., a keyboard, a keypad, controller, a mouse, a microphone, a touch screen, a sensor) and output devices such as (e.g., a computer screen, printer, or a speaker).

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, C++ or the like, and conventional procedural programming languages, such as the C programming language or similar programming languages. The computer readable program instructions may execute on a supercomputer, a compute cluster, or the like. The computer-executable instructions described herein can be downloaded to respective computing/processor devices from a computer-readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processor device receives computer readable program instructions from the network and forwards the computer readable program instructions for storage in a computer readable storage medium within the respective computing/processor device.

The computing device may execute an appropriate operating system such as LINUX®, UNIX®, MICROSOFT® WINDOWS®, APPLE® MACOS®, IBM® OS/2®, ANDROID, and/or the like. The computing device may advantageously be equipped with a network communication device such as a network interface card, a modem, or other network connection device suitable for connecting to one or more networks.

A computing device may advantageously contain control logic, or program logic, or other substrate configuration representing data and instructions, which cause the computing device to operate in a specific and predefined manner as, described herein. In particular, the computing device programs, when executed, enable a control processor to perform and/or cause the performance of features or operations of the present disclosure. The control logic may advantageously be implemented as one or more modules. The modules may advantageously be configured to reside on the computing device memory and execute on the one or more processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like. The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells. The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent. In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single dataset or may be distributed over different locations including over different storage devices, and may exist, at least partially, merely as electronic signals on a system or network. Where a module or portions of a module are implemented in software, the program code may be stored and/or propagated on in one or more computer readable medium(s).

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a "circuit," "module," or "system." Furthermore, aspects of the present disclosure may take the form of a computer program product embodied in one or more computer readable medium(s) having program code embodied thereon.

It should be understood that manipulations within the computing device are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computing device or computing devices.

It should also be understood that the programs, modules, processes, methods, and the like, described herein are but an exemplary implementation and are not related, or limited, to any particular computing device, apparatus, or computer language. Rather, various types of general- purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated systems with hard-wired logic or programs stored in nonvolatile memory, such as, by way of example, read-only memory (ROM).

The system may include one or more machine learning models, such as neural networks. The machine learning models may include supervised or unsupervised learning algorithms. For example, a neural network may include a deep neural network (DNN) (e.g., a deep auto-encoder neural network (deep ANN) or a convolutional neural network (CNN)) with an input layer, a plurality of hidden layers, and an output layer. Each layer may have one or more nodes where each node in a current layer is connected to every other node in a previous layer and a next layer (i.e., a fully-connected neural network), or not every node in each layer may be connected to every node in the previous and next layers. Each node in the input layer can be assigned a value and output that value to every node in the next layer (e.g., hidden layer). The nodes in the input layer can represent features about a particular environment or setting. Each node in the hidden layers can receive an outputted value from nodes in a previous layer (e.g., input layer) and associate each of the nodes in the previous layer with a weight. Each hidden node can then multiply each of the received values from the nodes in the previous layer with the weight associated with the nodes in the previous layer and output the sum of the products to each node in the next layer. Nodes in the output layer can handle input values received from the nodes in the hidden layer in a similar fashion. The output value of each output node can output information in a predefined format, where the information has some relationship to the corresponding information from the previous layer. Example outputs may include, but are not limited to, classifications, relationships, measurements, instructions, and recommendations. The output nodes can also be used to classify any of a wide variety of objects and other features and otherwise output any of a wide variety of desired information in desired formats.

Once a given network has been structured for a task, the neural network can be trained using a training dataset. A training system may use a training dataset to train the machine learning models to perform various functions based on input data to predict output data. Supervised learning uses a training dataset to teach models to yield the desired output. The training dataset can include inputs and desired outputs, which allow the model to learn over time. The network processes the inputs and compares the resulting outputs against a set of expected or desired outputs. Errors are then propagated back through the system. The training can adjust to change the weights that control the untrained neural network. The training process occur can repeatedly as the network weights are adjusted to refine the output generated by the neural network. The training process can continue until the neural network reaches a statistically desired accuracy associated with a trained neural network. The trained neural network can then be deployed to implement any number of machine learning operations to output a result. Unsupervised learning is a learning method in which the network uses algorithms to analyze and cluster unlabeled data to discover hidden patterns or data groupings. The training dataset includes input data without any associated output data. The untrained neural network can learn groupings within the unlabeled input and determine how individual inputs relate to the overall dataset. Unsupervised training can be used to for three main tasks-clustering, association, and dimensionality. Clustering is a data mining technique that groups unlabeled data based on similarities and differences, association is a rule-based method for finding relationships between variables in a given dataset, and dimensionality reduction is used when a given dataset's number of features (dimensions) is too high. Variations of supervised and unsupervised training may also be employed. Semi-supervised learning is a technique in which the training dataset includes a mix of labeled and unlabeled data of the same distribution. Incremental learning is a variant of supervised learning in which input data is continuously used to train the model further. Incremental learning enables the trained neural network to adapt to the new data without forgetting the knowledge instilled within the network during initial training.

A convolutional neural network (CNN) is a type of DNN having three additional features: local receptive fields, shared weights, and pooling. The input layer and output layer of a CNN function similar to the input and output layers of a DNN. The CNN is distinguished from a DNN in that the hidden layers of the DNN are replaced with one or more convolutional layers, pooling layers, and fully connected layers. The use of localized receptive fields involves having nodes in the convolutional layers to receive inputs from localized regions in the previous layer. The use of shared weights involves having each node in a convolutional layer assigning the same set of weights to the relative positions of a localized region. The input layer of the CNN can include data representing an image. The image can be passed through a convolutional hidden layer, an optional non-linear activation layer, a pooling hidden layer, and/or a fully connected hidden layers to get an output at the output layer. The convolutional hidden layer analyzes the image data of the input layer. Each node of the convolutional hidden layer is connected to a region of nodes (pixels) of the input image called a receptive field. The convolutional hidden layer can be considered as one or more filters (each filter corresponding to a different activation or feature map), with each convolutional iteration of a filter being a node or neuron of the convolutional hidden layer. The mapping from the input layer to the convolutional hidden layer is referred to as an activation map or feature map. The activation map includes a value for each node representing the filter results at each location of the input volume. The activation map can include an array containing the various total sum values resulting from each iteration of the filter on the input volume. The convolutional hidden layer can include several activation maps to identify multiple features in an image. A pooling hidden layer can be applied after the convolutional hidden layer and is used to simplify the information in the output from the convolutional hidden layer. The pooling hidden layer can take each activation map output from the convolutional hidden layer and generate a condensed activation map using a pooling function. The pooling function can be applied to each activation map in the convolutional hidden layer. The final layer of connections in the network is a fully connected layer that connects every node from the pooling hidden layer to every one of the output nodes in the output layer. The fully connected layer can obtain the output of the previous pooling layer, which should represent the activation maps of high-level features, and determine the features that most correlate to a particular class. For example, the fully connected layer can determine the high-level features that most strongly correlate to a particular class and can include weights (nodes) for the high-level features. A product can be computed between the weights of the fully connected layer and the pooling hidden layer to obtain probabilities for the different classes. For example, if the CNN is being used to predict that an object is a person, high values will be present in the activation maps that represent high-level features of people (e.g., two legs are present, a face is present at the top of the object, two eyes are present at the top left and top right of the face, a nose is present in the middle of the face, etc.).

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer-executable instructions. These computer- executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-executable instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

Those skilled in the art will recognize improvements and modifications to the preferred embodiments of the present disclosure. All such improvements and modifications are considered within the scope of the concepts disclosed herein and the claims that follow.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. A computer-implemented method for creating dynamic datasets for machine learning models, comprising:
accessing, by a computing device, a dataset for a machine learning model associated with a user, group of users, organization, or subject matter;
generating, by the computing device, at least one feedback field configured for an input to provide additional context, analysis, or reasoning for the user, group of users, organization, or subject matter;
receiving, by the computing device, additional context, analysis, or reasoning from the at least one feedback field;
applying, by the computing device, the additional context, analysis, or reasoning to the dataset to create a dynamic dataset for the machine learning model;
applying, by the computing device, the machine learning model informed by the dynamic dataset to workstreams, analysis, or decisions for the user, group of users, organization, or subject matter based on permissions and securities of the user, group of users, organization, or subject matter; and
receiving, by the computing device, an output generated by the machine learning model, the output comprising a response tailored to the user, group of users, organization, or subject matter.

2. The computer-implemented method of claim 1, further comprising:
transmitting the dynamic dataset to a computing device associated with another user, group of users, or organization based on the permissions and securities of the user, group of users, organization, or subject matter and permissions and securities of the other user or organization;
receiving additional context, analysis, or reasoning from the other user or organization; and
applying the additional context, analysis, or reasoning from the other user or organization to the dynamic dataset.

3. A computer-implemented method for refinement and inference of datasets for machine learning models, comprising:
generating, by a computing device, a prompt for user input;
receiving, by the computing device, a response to the prompt from a user;
routing, by the computing device, the response to the prompt to a machine learning model through a dynamic dataset comprising a rule library and a project context;
receiving, by the computing device, a proposed response to the prompt from the machine learning model;
performing, by the computing device, a comparison of the response to the prompt to the proposed response to the prompt;
generating, by the computing device, feedback based on the comparison, wherein the comparison indicates whether the proposed response to the prompt is consistent or inconsistent with the response to the prompt; and
updating, by the computing device, one or more of the rule library or the project context based on the feedback.

4. The computer-implemented method of claim 3, further comprising:
subsequent to updating the one or more of the project context or the rule library based on the feedback, routing the response to the prompt to the machine learning model through the dynamic dataset;
receiving a second proposed response to the prompt from the machine learning model;
performing a second comparison of the response to the prompt to the second proposed response to the prompt;
generating additional feedback based on the second comparison, wherein the second comparison indicates whether the second proposed response to the prompt is consistent or inconsistent with the response to the prompt; and
receiving one or more updates to one or more of the rule library or the project context when the additional feedback indicates inconsistent responses.

5. The computer-implemented method of claim 3, wherein the machine learning model comprises a generative AI model or a large language model (LLM), and wherein the machine learning model is associated with the user.

6. The computer-implemented method of claim 3, wherein performing the comparison of the response to the prompt to the proposed response to the prompt occurs in real-time; and wherein generating the feedback based on the comparison occurs in real-time.

7. The computer-implemented method of claim 3, further comprising:
generating a notification comprising the feedback, wherein the feedback indicates whether the proposed response to the prompt is consistent or inconsistent with the response to the prompt; and
transmitting the notification to a computing device associated with the user and configured to display the notification.

8. The computer-implemented method of claim 3, further comprising:
receiving one or more of information, preferences, reasoning, or understanding from the user; and
updating the rule library based on the one or more of information, preferences, reasoning, or understanding.

9. The computer-implemented method of claim 3, wherein the rule library includes a user-controlled rule set comprising at least one rule and a table of authorities regarding rules or understandings.

10. The computer-implemented method of claim 9, wherein the table of authorities includes one or more of user preferences or organizational preferences.

11. The computer-implemented method of claim 3, wherein the rule library is configured to be used by a plurality of organizations, wherein at least one organization from among the plurality of organizations uses a different machine learning model from other organizations in the plurality of organizations.

12. The computer-implemented method of claim 3, wherein the rule library comprises security and access controls configured to allow sharing of knowledge across one or more of users, organizations, or systems.

13. The computer-implemented method of claim 3, wherein the rule library is de-identified and includes non-user-specific preferences form a general knowledge set for use by other users.

14. The computer-implemented method of claim 3, wherein the rule library is integrated in an external system and accessible from the external system.

15. The computer-implemented method of claim 3, further comprising:
executing a request using a rule library from another user; and
generating a response from the machine learning model based on the request.

16. The computer-implemented method of claim 3, further comprising:
receiving one or more suggestions for one or more of context, analysis, or decisions, wherein the one or more suggestions correspond to an organization; and
including the one or more suggestions in the rule library, wherein the rule library corresponds to the organization.

17. The computer-implemented method of claim 3, further comprising:
receiving one or more of information, preferences, reasoning, or understanding; and
updating the project context based on the one or more of information, preferences, reasoning, or understanding.

18. The computer-implemented method of claim 3, further comprising, generating one or more recommendations comprising one or more of actions, decisions, or outcomes based on a context of user, group, or organizational work process.

19. The computer-implemented method of claim 3, further comprising:
receiving, from an organization or group of users, one or more of a recommended action, decision, or outcome for users of the organization or group of users;
generating, based on the one or more of a recommended action, decision, or outcome for users of the organization or group of users, an alert when a user from the organization or group of users deviates from the one or more of a recommended action, decision, or outcome; and
sending the alert to the organization or group of users.

20. A system for refinement and inference of datasets for machine learning models, comprising:
at least one machine learning model comprising a generative AI model or a large language model (LLM);
at least one memory storing the at least one machine learning model and non-transitory computer-executable instructions; and
at least one processor;
wherein, when executed by the at least one processor, the non-transitory computer-executable instructions cause the at least one processor to perform operations comprising:
accessing a dataset for the at least one machine learning model associated with a user;
receiving additional context, analysis, or reasoning from the user;
applying the additional context, analysis, or reasoning to the dataset to create a dynamic dataset for the at least one machine learning model;
generating a prompt for user input;
receiving a response to the prompt from the user;
routing the response to the prompt to the at least one machine learning model through the dynamic dataset;
receiving a proposed response to the prompt from the at least one machine learning model;
performing a comparison of the response to the prompt to the proposed response to the prompt;
generating feedback based on the comparison, wherein the comparison indicates whether the proposed response to the prompt is consistent or inconsistent with the response to the prompt; and
updating the dynamic dataset based on the feedback.
